(19) United States
(12) Patent Application Publication
(10) Pub. No.: US 2022/0004959 A1
(43) Pub. Date: Jan. 6, 2022

(54) METHOD AND SYSTEM FOR PREFILTERING IN RIDE-HAILING PLATFORMS

(71) Applicant: Beijing DiDi Infinity Technology and Development Co., Ltd., Beijing (CN)

(72) Inventors: Liang TANG, Santa Clara, CA (US); Bo TAN, Sunnyvale, CA (US)

(21) Appl. No.: 16/920,639

(22) Filed: Jul. 3, 2020

(51) Int. Cl. G06Q 10/06; G06Q 10/04; G06Q 10/02; G06F 17/15; G06K 9/62; G06N 20/00; G06Q 50/30

(52) U.S. Cl. CPC G06Q 10/06393; G06Q 10/04; G06Q 10/02; G06Q 50/30; G06K 9/623; G06K 9/6201; G06N 20/00; G06F 17/15

(57) ABSTRACT

Methods, systems, and apparatus, including computer programs encoded on computer storage media, for prefiltering pending trip requests in a ride-hailing platform. An exemplary method comprises: determining a plurality of feature weight vectors, wherein each of the plurality of feature weight vectors comprises a plurality of feature weights corresponding to a plurality of features for prefiltering rider-driver pairs; simulating dispatches of a plurality of historical trips with prefiltering based on each of the plurality of feature weight vectors to obtain a plurality of scores; training a surrogate model based on the plurality of feature weight vectors in the feature weight matrix and the plurality of scores; constructing an optimization model comprising the surrogate model as an objective function; determining the optimal feature weight vector by solving the optimization model; and prefiltering pending rider-driver pairs in the ride-hailing platform based on the optimal feature weight vector.

### TECHNICAL FIELD

The disclosure relates generally to systems and methods for prefiltering in ride-hailing platforms, in particular, efficient and adaptive prefiltering for order dispatching in a ride-hailing environment.

### BACKGROUND

On-demand ride-hailing services have seen rapid expansion in recent years. It is critical for the ride-hailing service providers to match a rider's request with a proper driver in real-time. The state-of-the-art matching algorithms usually involve solving a global optimization model, such as a Vehicle Routing Problem (VRP), for a batch of drivers and riders to determine optimal order dispatching decisions. However, when the number of drivers and riders in each batch is large, solving the optimization model will incur a high computational cost and may be impractical for large-scale implementation. A popular remedy is to perform prefiltering to reduce the number of possible rider-driver matching candidates before solving the optimization model. However, existing prefiltering methods are often inflexible and computationally expensive. It is desirable to design a light-weight and flexible prefiltering method for order dispatching in ride-hailing platforms.

### SUMMARY

Various embodiments of the present specification may include systems, methods, and non-transitory computer-readable media for constructing a virtual environment for a ride-hailing platform.

According to one aspect, a method for prefiltering in a ride-hailing platform may comprise: determining a feature weight matrix comprising a plurality of feature weight vectors, wherein each of the plurality of feature weight vectors comprises a plurality of feature weights corresponding to a plurality of features for prefiltering rider-driver pairs; simulating dispatches of a plurality of historical trips with prefiltering based on each of the plurality of feature weight vectors in the feature weight matrix to obtain a plurality of scores, wherein the plurality of scores respectively correspond to the plurality of feature weight vectors; training a surrogate model based on the plurality of feature weight vectors in the feature weight matrix and the plurality of scores, wherein the trained surrogate model takes a given feature weight vector as input and predicts a corresponding score; constructing an optimization model comprising the surrogate model as an objective function and a plurality of decision variables corresponding to a plurality of feature weights of an optimal feature weight vector; determining the optimal feature weight vector by solving the optimization model; and prefiltering pending rider-driver pairs in the ride-hailing platform based on the optimal feature weight vector.

In some embodiments, determining the feature weight matrix comprises: determining a plurality of feature weight matrix candidates; determining a correlation coefficient for each of the plurality of feature weight matrix candidates; and identifying, from the plurality of feature weight matrix candidates, the feature weight matrix with a minimum correlation coefficient.

In some embodiments, each of the plurality of features for prefiltering rider-driver pairs is associated with a weight range, and the determining a plurality of feature weight matrix candidates comprises: for each of the plurality of features, dividing the corresponding weight range into a plurality of contiguous intervals of equal probabilities; determining a feature weight matrix candidate comprising a plurality of candidate feature weight vectors, wherein each of the plurality of candidate feature weight vectors comprises a plurality of feature weights respectively selected from the plurality of contiguous intervals; and repeating the step of determining a feature weight matrix candidate for a plurality of times to obtain the plurality of feature weight matrix candidates.

In some embodiments, the determining a correlation coefficient for each of the plurality of feature weight matrix candidates comprises: determining a Pearson correlation coefficient for each pair of feature weight vectors in the each feature weight matrix candidate to obtain a plurality of Pearson correlation coefficients; and determining a maximum Pearson correlation coefficient of the plurality of Pearson correlation coefficients as the correlation coefficient for the each feature weight matrix candidate.

In some embodiments, the simulating dispatches of a plurality of historical trips with prefiltering based on each of the plurality of feature weight vectors in the feature weight matrix to obtain a plurality of scores comprises, for each of the plurality of feature weight vectors: determining one or more Key Performance Indicator (KPI) scores by dispatching the plurality of historical trips with prefiltering based on the feature weight vector in a simulation; and determining a score for the feature weight vector as a weighted sum of the one or more KPI scores.

In some embodiments, the one or more KPI scores comprise at least one of the following: a trip completion rate, a number of trips, a gross merchandise value, a profit, a match rate, a matching efficiency measured by relative cost saving.

In some embodiments, the method may further comprise obtaining a surrogate score of the optimal feature weight vector by inputting the optimal feature weight vector into the surrogate model; obtaining a simulated score of the optimal feature weight vector by simulating dispatches of the plurality of historical trips with prefiltering based on the optimal feature weight vector; determining whether a difference between the surrogate score and the simulated score is greater than a threshold; if the difference is greater than the threshold, retraining the surrogate model based at least on the optimal feature weight vector and the simulated score.

In some embodiments, the surrogate model comprises a Quadratic Polynomial Function.

In some embodiments, the method may further comprise collecting one or more real-world KPI scores for each of a plurality of real-world dispatched orders based on the optimal feature weight vector; determining a real-world score for each of the plurality of real-world dispatched orders based on the one or more real-world KPI scores; and retraining the surrogate model based at least on the optimal feature weight vector and the plurality of real-world scores of the plurality of real-world dispatched orders.

In some embodiments, the plurality of features comprise one or more of the following: travel distance from a driver to a rider and travel time from the driver to the rider.

In some embodiments, a rider-driver pair corresponds to a carpool order comprising a plurality of co-riders, and the plurality of features comprise at least one of the following features: a shared distance among the plurality of co-riders, a shared time among the plurality of co-riders, and a cost-saving between the carpool order and a sum of hypothetical solo trip orders of the plurality of co-riders.

In some embodiments, the prefiltering pending rider-driver pairs in the ride-hailing platform based on the optimal feature weight vector comprises: for each of the pending rider-driver pairs, determining a plurality of feature values corresponding to the plurality of features of the pending rider-driver pair based on rider information and driver information of the pending rider-driver pair; determining a weighted sum of the plurality of feature values based on the plurality of feature weights in the optimal weight vector; and selecting one or more of the pending rider-driver pairs with smallest weighted sums for order matching.

In some embodiments, the prefiltering pending rider-driver pairs in the ride-hailing platform based on the optimal feature weight vector comprises: for each of the pending rider-driver pairs, determining a plurality of feature values corresponding to the plurality of features of the pending rider-driver pair based on rider information and driver information of the pending rider-driver pair; determining a weighted sum of the plurality of feature values based on the plurality of feature weights in the optimal weight vector; and selecting one or more of the pending rider-driver pairs with weighted sums smaller than a threshold for order matching.

According to another aspect, a system for prefiltering in a ride-hailing platform may comprise one or more processors and one or more non-transitory computer-readable memories coupled to the one or more processors, the one or more non-transitory computer-readable memories storing instructions that, when executed by the one or more processors, cause the system to perform operations comprising: determining a feature weight matrix comprising a plurality of feature weight vectors, wherein each of the plurality of feature weight vectors comprises a plurality of feature weights corresponding to a plurality of features for prefiltering rider-driver pairs; simulating dispatches of a plurality of historical trips with prefiltering based on each of the plurality of feature weight vectors in the feature weight matrix to obtain a plurality of scores, wherein the plurality of scores respectively correspond to the plurality of feature weight vectors; training a surrogate model based on the plurality of feature weight vectors in the feature weight matrix and the plurality of scores, wherein the trained surrogate model takes a given feature weight vector as input and predicts a corresponding score; constructing an optimization model comprising the surrogate model as an objective function and a plurality of decision variables corresponding to a plurality of feature weights of an optimal feature weight vector; determining the optimal feature weight vector by solving the optimization model; and prefiltering pending rider-driver pairs in the ride-hailing platform based on the optimal feature weight vector.

According to yet another aspect, a non-transitory computer-readable storage medium for prefiltering in a ride-hailing platform may store instructions that, when executed by one or more processors, cause the one or more processors to perform operations comprising determining a feature weight matrix comprising a plurality of feature weight vectors, wherein each of the plurality of feature weight vectors comprises a plurality of feature weights corresponding to a plurality of features for prefiltering rider-driver pairs; simulating dispatches of a plurality of historical trips with prefiltering based on each of the plurality of feature weight vectors in the feature weight matrix to obtain a plurality of scores, wherein the plurality of scores respectively correspond to the plurality of feature weight vectors; training a surrogate model based on the plurality of feature weight vectors in the feature weight matrix and the plurality of scores, wherein the trained surrogate model takes a given feature weight vector as input and predicts a corresponding score; constructing an optimization model comprising the surrogate model as an objective function and a plurality of decision variables corresponding to a plurality of feature weights of an optimal feature weight vector; determining the optimal feature weight vector by solving the optimization model; and prefiltering pending rider-driver pairs in the ride-hailing platform based on the optimal feature weight vector.

These and other features of the systems, methods, and non-transitory computer-readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 illustrates an exemplary system to which prefiltering in a ride-hailing platform may be applied, in accordance with various embodiments.

FIG. 2 illustrates exemplary prefiltering and order matching processes in a ride-hailing platform in accordance with various embodiments.

FIG. 3 illustrates an exemplary method for obtaining a feature weight matrix in accordance with various embodiments.

FIG. 4 illustrates an exemplary flow chart of a method for prefiltering in a ride-hailing platform in accordance with various embodiments.

FIG. 5 illustrates an exemplary method for prefiltering in a ride-hailing platform in accordance with various embodiments.

FIG. 6 illustrates a block diagram of a computer system in which any of the embodiments described herein may be implemented.

### DETAILED DESCRIPTION

Specific, non-limiting embodiments of the present invention will now be described with reference to the drawings. It should be understood that particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope, and contemplation of the present invention as further defined in the appended claims.

In the current ride-hailing practices, prefiltering is usually performed before riders and drivers are matched to filter out low-quality matching (or pairing) candidates and keep the high-quality ones for dispatching. The prefiltering may evaluate a large number of possible pairing candidates (e.g., each rider is paired with all available drivers) in a short period of time. The evaluation may be accomplished by simulation based on various features of each pair candidate. A ride-hailing platform may provide a threshold for each of the plurality of features, and input a pairing candidate to a simulation system to determine whether the pairing candidate meets all the thresholds of the plurality of features. When the pairing candidate fails to meet all the thresholds, it is filtered out as a low-quality pairing candidate. In some cases, the ride-hailing platform may provide a plurality of thresholds for each of the plurality of features, so that different combinations of thresholds may be evaluated and adopted for prefiltering in different scenarios.

The above-mentioned thresholds are usually determined by domain knowledge or through comparing a limited number of threshold candidate sets, which may not guarantee a reasonable performance at large scale or achieve an optimal key practice indicator (KPI) value at system level. For example, a ride-hailing platform may deal with millions of riders and drivers at a time, it may be computationally impossible to run simulations to determine the best threshold configuration. As a result, the thresholds determined through limited rounds of simulation (or the manually determined thresholds) may not be able to effectively filter out low-quality pairing candidates, or may mistakenly filter out high-quality pairing candidates.

In the current specification, instead of configuring thresholds for different features, some embodiments take the prefiltering features in a collective way to calculate a utility score for each pairing candidate. For example, a utility score uᵢⱼ may be obtained by calculating a weighted sum of different feature values of a pairing candidate (i, j), where i refers to a rider's index, and j refers to a driver's index. Formally, the utility score uᵢⱼ may be presented as a function:

$${u}_{ij} = {\sum }_{m ∈ M} {x}_{ijm} {β}_{m} \qquad ( 1 )$$

where M refers to the plurality of features for prefiltering (also called prefiltering features), m refers to the mₜₕ feature (also called feature m) of the plurality of features, xᵢⱼₘ refers to the value of the feature m of the pairing candidate (i, j), and βₘ refers to a weight (also called parameter) for the feature m. The utility function (1) may generate a utility score uᵢⱼ indicating the quality of the pairing candidate (i, j), and the score may be a weighted sum of a plurality of feature values of the pairing candidate (i, j). The following description discloses a method to determine the plurality of weights (e.g., the mₜₕ weight βₘ) corresponding to the plurality of features. With the determined weights, the utility score or quality of each pairing candidate may be easily determined by function (1). In some embodiments, the plurality of weights β may be updated periodically according to real-world feedbacks (e.g., based on the KPI values of order dispatch after deploying the plurality of weights β for prefiltering in the ride-hailing platform). This way, the prefiltering is more light-weight and flexible. In the following description, the term “weight” and “parameter” may be used interchangeably unless expressly stated otherwise.

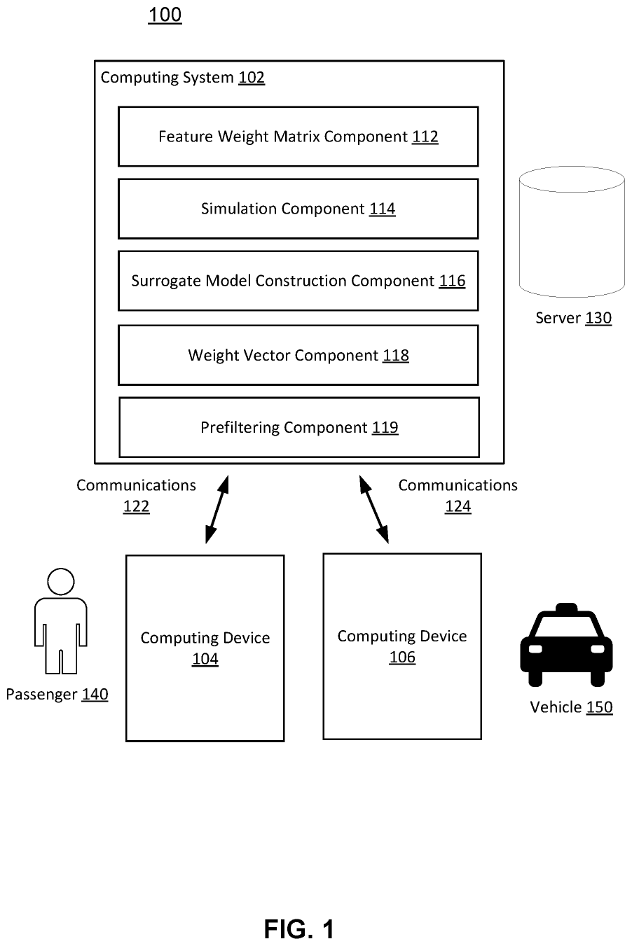

FIG. 1 illustrates an exemplary system 100 to which prefiltering in a ride-hailing platform may be applied, in accordance with various embodiments. The exemplary system 100 may include a computing system 102, a computing device 104, and a computing device 106. It is to be understood that although two computing devices are shown in FIG. 1, any number of computing devices may be included in the system 100. Computing system 102 may be implemented in one or more networks (e.g., enterprise networks), one or more endpoints, one or more servers, or one or more clouds. A server may include hardware or software which manages access to a centralized resource or service in a network. A cloud may include a cluster of servers and other devices that are distributed across a network.

The computing devices 104 and 106 may be implemented on or as various devices such as a mobile phone, tablet, server, desktop computer, laptop computer, vehicle (e.g., car, truck, boat, train, autonomous vehicle, electric scooter, electric bike), etc. The computing system 102 may communicate with the computing devices 104 and 106, and other computing devices. Computing devices 104 and 106 may communicate with each other through computing system 102, and may communicate with each other directly. Communication between devices may occur over the internet, through a local network (e.g., LAN), or through direct communication (e.g., BLUETOOTH™, radio frequency, infrared).

In some embodiments, the system 100 may include a ride-hailing platform. The ride-hailing platform may facilitate transportation service by connecting drivers of vehicles with passengers. The platform may accept requests for transportation from passengers, identify idle vehicles to fulfill the requests, arrange for pick-ups, and process transactions. For example, passenger 140 may use the computing device 104 to order a trip. The trip order may be included in communications 122. The computing device 104 may be installed with a software application, a web application, an API, or another suitable interface associated with the ride-hailing platform.

While the computing system 102 is shown in FIG. 1 as a single entity, this is merely for ease of reference and is not meant to be limiting. One or more components or one or more functionalities of the computing system 102 described herein may be implemented in a single computing device or multiple computing devices. In some embodiments, the computing system 102 may include a feature weight matrix component 112, a simulation component 114, a surrogate model construction component 116, a weight vector component 118, and a prefiltering component 119. Depending on the implementations, the computing system 102 may include more, fewer, or alternative components.

In some embodiments, the feature weight matrix component 112 may be configured to determine a feature weight matrix. The feature weight matrix may be an N*M matrix with N feature weight vectors, where each of the N feature weight vectors includes M weights corresponding to M features that are considered during prefiltering (also called M prefiltering features). In some embodiments, the N feature weight vectors may be considered as a plurality of different feature weight combinations to be evaluated. In some embodiments, the plurality (e.g., M) of features may include a travel distance for pick-up, a travel time for pick-up from a driver to a rider, whether a driver is moving toward or away from the rider, another suitable feature, or any combination thereof.

In some embodiments, the simulation component 114 may be configured to perform the above-mentioned evaluation of the plurality of different feature weight combinations in the feature weight matrix. The simulation component 114 may perform simulated prefiltering operations on a certain period of historical trip data, and adopt the order matching algorithm (e.g., order dispatching algorithm) in production to perform order matching based on the results of the simulated prefiltering operations. The resultant order matches may be quantified with one or more scores. In some embodiments, the one or more scores may include one or more key metric values (e.g., key practice indicators (KPI)). For example, the KPIs may include a trip completion rate, a number of trips completed, a gross merchandise value (GMV), a profit, a matching rate, a matching efficiency (e.g., measured by relative cost saving, specifically for carpool cases).

In some embodiments, the surrogate model construction component 116 may be configured to fit (e.g., train, or learn) a surrogate model with the simulation results of the simulation component 114. In some embodiments, the surrogate model may be a Quadratic Polynomial Function, a Radial Basis Functions (RBF), a Kriging model, a Support Vector Regression (SVR), or another suitable function. For simplicity, a Quadratic Polynomial Function is used as an example to demonstrate how to construct the surrogate model. In some embodiments, the simulation component 114 may generate a plurality of simulated scores by running prefiltering against a plurality of historical trips based on the plurality of feature weight vectors in the feature weight matrix. Formally, for the feature weight matrix X=[X₁^{T}, X₂^{T}, . . . , X_{N}^{T}]^{T}, the simulation component 114 may obtain the corresponding scores s=[s₁, s₂, . . . , S_{N}]^{T}, where X is a N*M matrix, Xᵢ^{T} refers to a feature weight vector with M weights corresponding to the M prefiltering features, sᵢ refers to the score corresponding to the i-th feature weight vector Xᵢ^{T}. By fitting the surrogate model with the feature weight vectors and the corresponding scores, the quadratic polynomial function may be represented by:

$$\hat{f} ( {X}_{n} ) = {β}_{0} + {\sum }_{i = 1}^{k} {β}_{i} {x}_{ni} + {\sum }_{i < j} {\sum }_{j} {β}_{ij} {x}_{ni} {x}_{nj} + {\sum }_{i = 1}^{k} {β}_{ii} {x}_{ni}^{2} \qquad ( 2 )$$

where Xₙ=[xₙ₁, xₙ₂, . . . , x_{nM}]^{T} is a M-dimensional point to be estimated, xₙᵢ refers to a weight for the i-th feature in the n-th feature weight vector, \hat{ƒ}(x) is the estimation of a real objective function ƒ(X). The learned ƒ(X) may represent the surrogate surface between feature weight vectors and corresponding scores.

In some embodiments, the weight vector component 118 may be configured to determine an optimal weight vector based on the surrogate model learned by the surrogate model construction component 116. For example, an optimization model may be constructed based on the surrogate model, i.e., \hat{ƒ}(x) in function (2). The optimization model may be subjected to a plurality of range constraints of the M feature weights. By solving the optimization model to reach the maximum score, an optimal feature weight vector Xₒₚₜᵢₘₐₗ may be obtained. The score ŝₒₚₜᵢₘₐₗ corresponding to Xₒₚₜᵢₘₐₗ may be obtained based on \hat{ƒ}(X). In some embodiments, this optimal feature weight vector Xₒₚₜᵢₘₐₗ may be directly deployed to perform prefiltering in the production environment (e.g., serving the live traffic in the ride-hailing platform). In other embodiments, this optimal feature weight vector Xₒₚₜᵢₘₐₗ may be further optimized. For example, the optimal feature weight vector Xₒₚₜᵢₘₐₗ may be fed into the simulation environment to obtain a simulation score sₒₚₜᵢₘₐₗ (e.g., by performing prefiltering against the historical trips using the weights in Xₒₚₜᵢₘₐₗ), and if a difference between Sₒₚₜᵢₘₐₗ and ŝₒₚₜᵢₘₐₗ is greater than a certain threshold E, the surrogate model may be further optimized. In some embodiments, the Xₒₚₜᵢₘₐₗ and the sₒₚₜᵢₘₐₗ may be added to the feature weight matrix and the corresponding scores for re-learning (re-fitting) the surrogate model.

In some embodiments, the prefiltering component 119 may be configured to perform prefiltering based on the weights in the optimal feature weight vector obtained by the weight vector component 118. The weights in the optimal feature weight vector respectively correspond to the plurality of prefiltering features. Based on function (1), each rider-driver pairing candidate may be scored with the weights and the corresponding feature values and may be filtered out based on the score. For example, if the score is below a first threshold, the rider-driver paring candidate may be filtered out. As another example, the rider-driver pairing candidate is promoted to the order matching phase when its score is greater than a second threshold. As yet another example, among a batch of rider-driver pairing candidates, a preset number of candidates with the top scores may be promoted to the order matching phase.

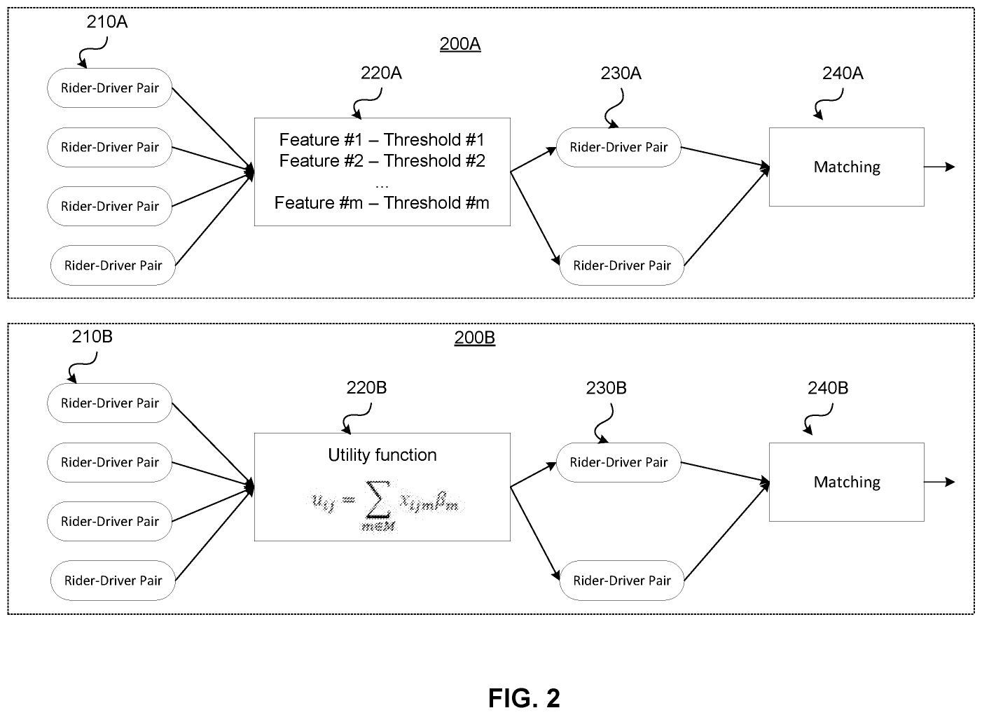

FIG. 2 illustrates exemplary prefiltering and order matching processes in a ride-hailing platform in accordance with various embodiments. For the sake of clarity, FIG. 2 compares an existing prefiltering and order matching pipeline 200A with a pipeline 200B involving an efficient and adaptive prefiltering. The pipelines shown in FIG. 2 are for illustrative purpose only, and may include more, fewer, or alternative phases depending on the implementation.

In the existing pipeline 200A, a plurality of riders and a plurality of drivers are to be matched. A plurality of rider-driver pairing candidates 210A may be prefiltered first to remove the low-quality candidates (e.g., the candidates yield low KPIs), and the remaining candidates 230A may be fed into the order matching algorithm 240A to generate the final matching results. For example, the rider-driver pairing candidates may include all combinations of each rider and each driver for solo trips, and all combinations of carpool riders and each driver for carpool trips. The exemplary prefiltering 220A may consider a plurality of features in order to filter out the low-quality candidates. Exemplary features may include a travel distance for pick-up, a travel time for pick-up from a driver to a rider, whether a driver is moving toward or away from the rider, another suitable feature, or any combination thereof. For each of the plurality of features, the prefiltering 220A may configure a plurality of corresponding thresholds. When the feature values of a paring candidate fail to meet all the feature thresholds, it may be filtered out as a low-quality candidate. During the matching phase 240A, the high-quality pairing candidates may be considered to generate the optimal matching results at system level.

In the pipeline 200B, a plurality of rider-driver pairing candidates 210B may be similarly prefiltered to generate the high-quality candidates 230B (e.g., the candidates yield high KPIs) for order matching 240B. Instead of configuring thresholds for the plurality features, the prefiltering 220B constructs a utility function to compute a utility score for each of the rider-driver pairing candidate 210B. In some embodiments, the utility function may be represented as a weighted sum of the feature values of each paring candidate 210B. The feature values may be determined based on the trip information associated with the paring candidate 210B. The weights (e.g., the parameters for the feature values) may be determined by the following method: simulating dispatches of a plurality of historical trips with prefiltering based on each of the plurality of feature weight vectors to obtain a plurality of scores, wherein the plurality of scores respectively correspond to the plurality of feature weight vectors; training a surrogate model based on the feature weight matrix and the plurality of scores, wherein the trained surrogate model takes a given feature weight vector as input and predicts a corresponding score; constructing an optimization model comprising the surrogate model as an objective function and a plurality of decision variables corresponding to the plurality of feature weights of an optimal feature weight vector; determining the optimal feature weight vector by solving the optimization model, where the optimal feature weight vector includes the weights.

In some embodiments, the surrogate model may be constructed with following steps: determining a feature weight matrix comprising a plurality of feature weight vectors, wherein each of the plurality of feature weight vectors comprises a plurality of feature weights corresponding to a plurality of features for prefiltering rider-driver pairs; obtaining a plurality of scores respectively for the plurality of feature weight vectors in the feature weight matrix by simulating dispatches of a plurality of historical trips with prefiltering based on each of the plurality of feature weight vectors; constructing a surrogate model based on the feature weight matrix and the plurality of scores. In some embodiments, the constructing a surrogate model may comprise: fitting a quadratic polynomial function as shown in function (2) with the plurality of feature weight vectors in the feature weight matrix and the corresponding scores. The resulting quadratic polynomial function may be determined as the utility function.

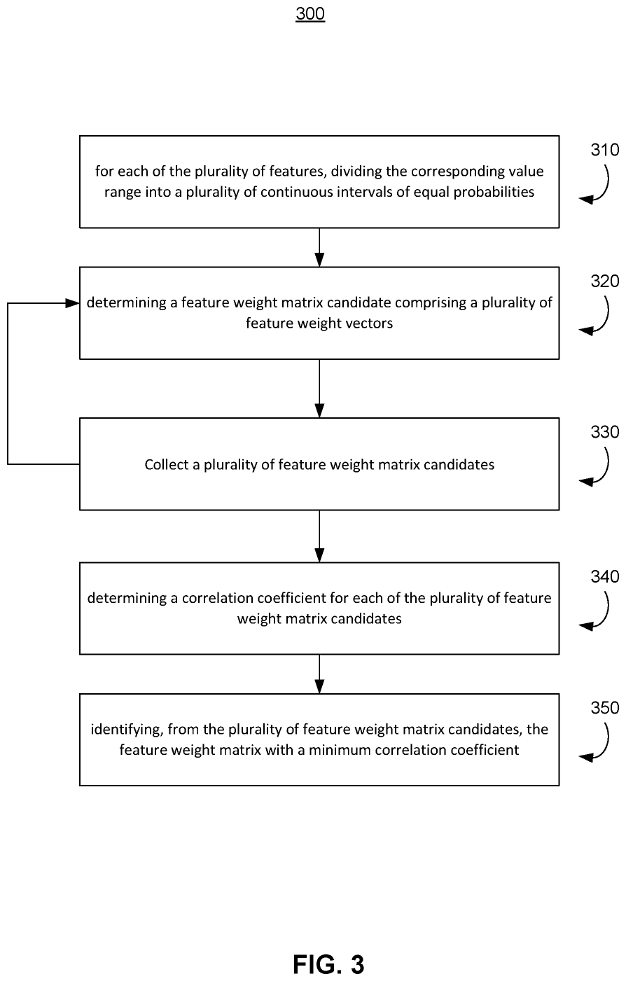

FIG. 3 illustrates an exemplary method 300 for obtaining a feature weight matrix in accordance with various embodiments. The method 300 is for illustrative purpose only, and may include more, fewer, or alternative steps. Prior to obtaining the feature weight matrix, it is presumed that the plurality of features for prefiltering are already determined. Each of the plurality of features may have a corresponding weight range from which the weight may be selected.

Step 310 may include, for each of the plurality of features, dividing the corresponding weight range into a plurality of contiguous intervals of equal probabilities. For example, for each parameter m, divide the range Rₘ (a range is composed of a lower bound and an upper bound) into N contiguous intervals of equal probabilities: Rₙₘ, n=1, 2, . . . , N, where Rₙₘ refers to the n-th interval for m-th feature.

Step 320 may include determining a feature weight matrix candidate comprising a plurality of feature weight vectors, wherein each of the plurality of feature weight vectors comprises a plurality of feature weights respectively selected from the plurality of contiguous intervals in a random manner; and repeating the step of determining a feature weight matrix candidate for a plurality of times to obtain the plurality of feature weight matrix candidates.

For example, within each interval Rₙₘ for m=1, 2, . . . , M and n=1, 2, . . . , N, a weight xₙₘ (a scalar value) may be randomly selected to represent the weight of the m-th feature in the utility function (e.g., βₘ in function (1)). By combining N values of xₙ₁ with N values of xₙ₂, at random and without replacement, N ordered pairs may be produced as [xₙ₁, xₙ₂], n=1, 2, . . . , N. The N pairs may then be combined with N values of xₙ₃, again at random and without replacement, to produce N ordered 3-tuples: [xₙ₁, xₙ₂, xₙ₃], n=1, 2, . . . , N. This process may be continued for all M features to generate N samples, denoted as Xₙ=[xₙ₁, xₙ₂, xₙ₃, . . . x_{nM}], =n=1, 2, . . . , N.

Step 330 may include repeating the step 320 to collect a plurality of feature weight matrix candidates. Since random parameter generation is fast and low-cost, a large number of feature weight matrix candidates may be collected in practice, e.g., 1000.

Step 340 may include determining a correlation coefficient for each of the plurality of feature weight matrix candidates. In some embodiments, the correlation coefficient for a feature weight matrix candidate may refer to the maximum correlation coefficient between every pair of feature weight vectors therein. Here, the correlation coefficient may refer to Pearson's correlation coefficient. For example, the correlation coefficient for a feature weight matrix candidate may be denoted as

Corr=Max corrᵢⱼ, i,j=1, 2, . . . , N and i!=j

where corrᵢⱼ is the Pearson's correlation coefficient between X₁ and Xᵢ (e.g., the i-th and j-th feature weight vectors in the feature weight matrix candidate. Pearson's correlation coefficient between two vectors A and B can be calculated by:

$${corr}_{AB} = \frac{cov ( A , B )}{{σ}_{A} {σ}_{B}}$$

where coy is the covariance, and σ is the standard deviation.

Step 350 may include identifying, from the plurality of feature weight matrix candidates, the feature weight matrix with a minimum correlation coefficient. For example, among a plurality of feature weight matrix candidates and based the corresponding correlation coefficients, the one with the smallest correlation coefficient may be selected. The selected feature weight matrix may be used to train a surrogate model to approximate the underlying relationship (e.g., a latent function) between the feature weight vectors in the feature weight matrix (e.g., the one with the minimum correlation coefficient) and corresponding prefiltering performance scores using the feature weight vectors. The trained surrogate model may take a given feature weight vector as an input, and generate a predicted prefiltering performance score as an output. In some embodiments, the prefiltering performance score of a feature weight vector may be obtained by simulating a prefiltering process against a plurality of historical trips and collecting the resultant KPI values of the trips after the prefiltering.

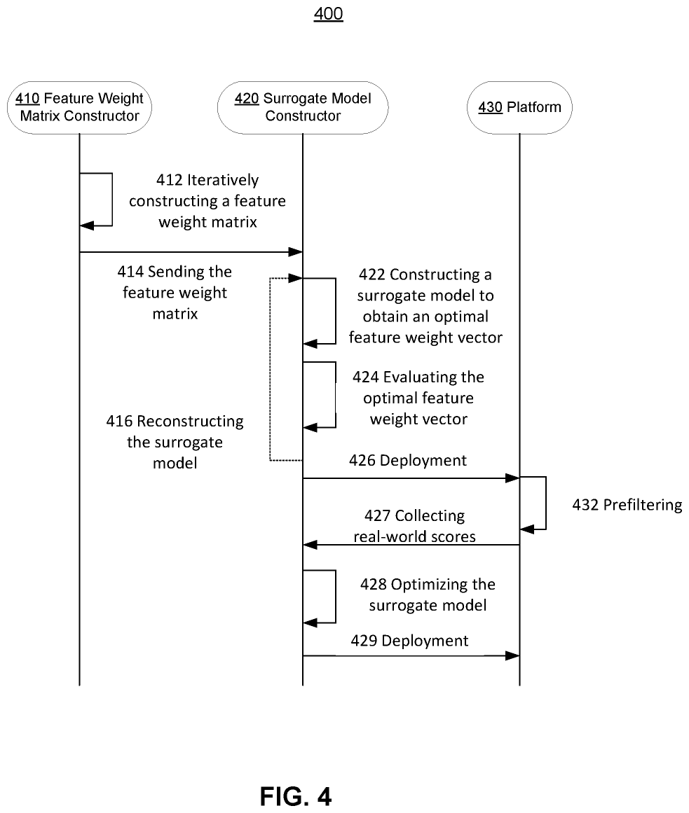

FIG. 4 illustrates an exemplary flow chart of a method 400 for prefiltering in a ride-hailing platform in accordance with various embodiments. The method 400 is merely illustrative. Depending on the implementation, the method 400 may have more, fewer, or alternative steps or components. The method 400 may be implemented by the computing system 102 in FIG. 1, and may incorporate the method of 300 in FIG. 3.

As shown, the exemplary method 400 may involve a feature weight matrix constructor 410, a surrogate model constructor 420, and a ride-hailing platform 430. The feature weight matrix constructor 410 may first iteratively construct a feature weight matrix at step 412. In some embodiments, the feature weight matrix may be determined based on the method 300 illustrated in FIG. 3. This determined feature weight matrix may then be sent to the surrogate model constructor 420 at step 414 to construct a surrogate model (e.g., a utility function).

The surrogate model constructor 420 may simulate the prefiltering using each of the feature weight vectors in the feature weight matrix against a plurality of historical trips, and obtain the corresponding scores. Here, the scores may correspond to one or more KPIs, such as a trip completion rate, a number of trips completed, a GMV, a profit, a matching rate, a matching efficiency (e.g., measured by relative cost-saving, specifically for carpool cases). The score may refer to a KPI value when only one KPI is considered by the ride-hailing platform 430, and refer to a weighted sum of multiple KPI values when multiple KPIs are considered by the ride-hailing platform 430. By fitting a surrogate model, such as by a quadratic polynomial function, to the plurality of feature weight vectors and corresponding scores, a utility function may be obtained (e.g., function (2)). In some embodiments, other surrogate models such as RBF, Kriging model, or SVR may be adopted.

With the surrogate model, an optimal feature weight vector may be obtained at step 422, for example, by solving an optimization problem constructed based on the surrogate model with range constraints of the feature weights. In some embodiments, this optimal feature weight vector may be directly deployed at step 426; while in other embodiments, this optimal feature weight vector may be further examined and optimized in steps 424 and 416. For example, the optimal feature weight vector may be fed into a simulation environment to obtain a simulated score (e.g., the score based on one or more KPI values). If a difference between the simulated score and the score generated by the surrogate model for the optimal feature weight vector is greater than a threshold, it means the surrogate model is not sufficiently approximating the simulation environment. In this case, the optimal feature weight and the corresponding simulated score may be added to the training data to re-construct the surrogate model at step 416.

Once the optimal feature weight vector is determined, it may be deployed at step 426 in the ride-hailing platform 430 to perform prefiltering 432. The prefiltering 432 may filter out low-quality rider-driver pairing candidates (e.g., with low utility scores) and only allow the high-quality rider-driver pairing candidates to be fed into the matching algorithm (e.g., order dispatching algorithm) to reduce the overall computational cost. In some embodiments, the prefiltering step 432 may include, for each of the pending rider-driver pairs, determining a plurality of feature values of the pending rider-driver pair based on rider information and driver information of the pending rider-driver pair; determining a weighted sum of the plurality of feature values based on the plurality of feature weights in the optimal weight vector; and selecting one or more of the pending rider-driver pairs with smallest weighted sums for order matching, or selecting one or more of the pending rider-driver pairs with weighted sums smaller than a threshold for order matching.

In some embodiments, after the optimal feature weight vector is deployed to perform prefiltering, the real-world metrics of rider-driver pairing candidates may be collected for a period of time. For example, given a rider-driver paring candidate, function (1) with the weights in the optimal feature vector may be adopted to compute the corresponding score; assuming the score is greater than a threshold and the rider-driver paring candidate is further evaluated by the matching algorithm and eventually dispatched, the platform 430 may determine an actual score (e.g., a weighted sum of KPIs) for this pairing candidate. This way, a plurality of real-world scores may be collected by the ride-hailing platform 430 at step 427.

Based on the plurality of collected real-world scores, the surrogate model constructor 420 may further optimize the surrogate model to further approximate the surrogate surface with the real-world surface. Here, the “surface” may refer to a functional relationship between feature weights and scores. For example, the deployed optimal feature weight vector and the real-world scores may be added as new training data, and the surrogate model may be refined based on the new training data at step 428. Subsequently, a new optimal feature weight vector may be obtained based on the refined surrogate model (e.g., by solving an optimization problem constructed based on the refined surrogate model). The new optimal feature weight vector may then be deployed at step 429 in the ride-hailing platform 430 to perform prefiltering for the next period of time.

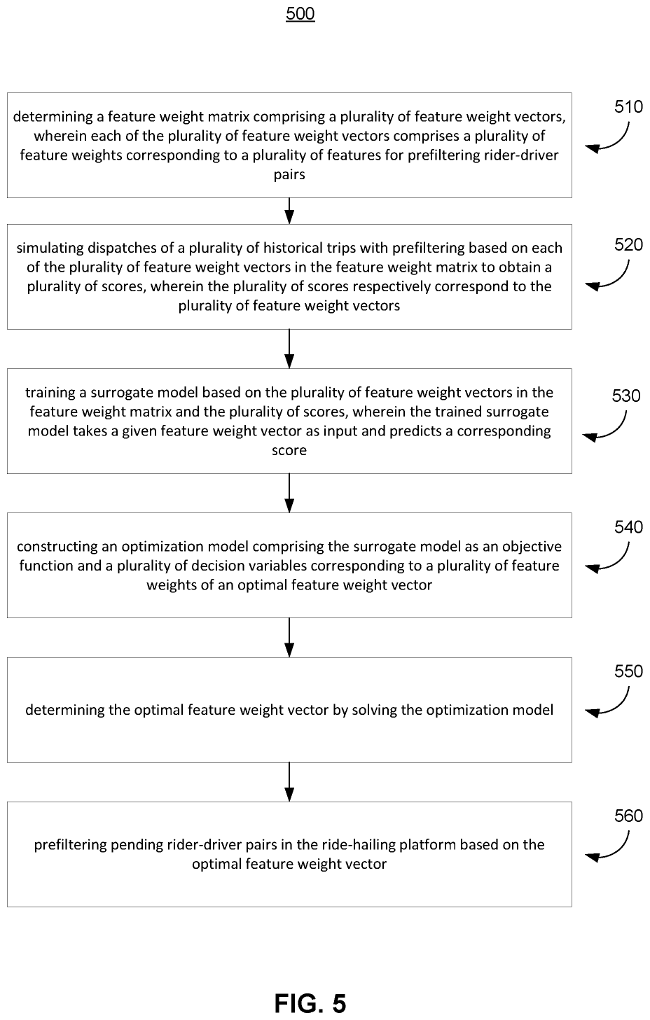

FIG. 5 illustrates an exemplary method 500 for prefiltering in a ride-hailing platform in accordance with various embodiments. The method 500 may be implemented in an environment shown in FIG. 1. The method 500 may be performed by a device, apparatus, or system illustrated by FIGS. 1-4, such as the system 102. Depending on the implementation, the method 500 may include additional, fewer, or alternative steps performed in various orders or in parallel.

The Block 510 includes determining a feature weight matrix comprising a plurality of feature weight vectors, wherein each of the plurality of feature weight vectors comprises a plurality of feature weights corresponding to a plurality of features for prefiltering rider-driver pairs.

In some embodiments, determining the feature weight matrix comprises: determining a plurality of feature weight matrix candidates; determining a correlation coefficient for each of the plurality of feature weight matrix candidates; and identifying, from the plurality of feature weight matrix candidates, the feature weight matrix with a minimum correlation coefficient. In some embodiments, each of the plurality of features for prefiltering rider-driver pairs is associated with a weight range, and the determining a plurality of feature weight matrix candidates comprises: for each of the plurality of features, dividing the corresponding weight range into a plurality of contiguous intervals of equal probabilities; determining a feature weight matrix candidate comprising a plurality of candidate feature weight vectors, wherein each of the plurality of candidate feature weight vectors comprises a plurality of feature weights respectively selected from the plurality of contiguous intervals; and repeating the step of determining a feature weight matrix candidate for a plurality of times to obtain the plurality of feature weight matrix candidates.

In some embodiments, the determining a correlation coefficient for each of the plurality of feature weight matrix candidates comprises: determining a Pearson correlation coefficient for each pair of feature weight vectors in the each feature weight matrix candidate to obtain a plurality of Pearson correlation coefficients; and determining a maximum Pearson correlation coefficient of the plurality of Pearson correlation coefficients as the correlation coefficient for the each feature weight matrix candidate. In some embodiments, the plurality of features comprise one or more of the following: travel distance from a driver to a rider and travel time from the driver to the rider.

In some embodiments, a rider-driver pair corresponds to a carpool order comprising a plurality of co-riders, and the plurality of features comprise at least one of the following features: a shared distance among the plurality of co-riders, a shared time among the plurality of co-riders, and a cost saving between the carpool order and a sum of hypothetical solo trip orders of the plurality of co-riders.

The Block 520 includes simulating dispatches of a plurality of historical trips with prefiltering based on each of the plurality of feature weight vectors in the feature weight matrix to obtain a plurality of scores, wherein the plurality of scores respectively correspond to the plurality of feature weight vectors. In some embodiments, the simulating dispatches of a plurality of historical trips with prefiltering based on each of the plurality of feature weight vectors in the feature weight matrix to obtain a plurality of scores comprises, for each of the plurality of feature weight vectors: determining one or more Key Performance Indicator (KPI) scores by dispatching the plurality of historical trips with prefiltering based on the feature weight vector in a simulation; and determining a score for the feature weight vector as a weighted sum of the one or more KPI scores. In some embodiments, the one or more KPI scores comprise at least one of the following: a trip completion rate, a number of trips, a gross merchandise value, a profit, a match rate, a matching efficiency measured by relative cost saving.

The Block 530 includes training a surrogate model based on the plurality of feature weight vectors in the feature weight matrix and the plurality of scores, wherein the trained surrogate model takes a given feature weight vector as input and predicts a corresponding score. In some embodiments, the surrogate model comprises a Quadratic Polynomial Function.

The Block 540 includes constructing an optimization model comprising the surrogate model as an objective function and a plurality of decision variables corresponding to a plurality of feature weights of an optimal feature weight vector.

The Block 550 includes determining the optimal feature weight vector by solving the optimization model.

The Block 560 includes prefiltering pending rider-driver pairs in the ride-hailing platform based on the optimal feature weight vector. In some embodiments, the prefiltering pending rider-driver pairs in the ride-hailing platform based on the optimal feature weight vector comprises: for each of the pending rider-driver pairs, determining a plurality of feature values corresponding to the plurality of features of the pending rider-driver pair based on rider information and driver information of the pending rider-driver pair; determining a weighted sum of the plurality of feature values based on the plurality of feature weights in the optimal weight vector; and selecting one or more of the pending rider-driver pairs with smallest weighted sums for order matching. In some embodiments, the prefiltering pending rider-driver pairs in the ride-hailing platform based on the optimal feature weight vector comprises: for each of the pending rider-driver pairs, determining a plurality of feature values corresponding to the plurality of features of the pending rider-driver pair based on rider information and driver information of the pending rider-driver pair; determining a weighted sum of the plurality of feature values based on the plurality of feature weights in the optimal weight vector; and selecting one or more of the pending rider-driver pairs with weighted sums smaller than a threshold for order matching.

In some embodiments, the method 500 may further comprise: obtaining a surrogate score of the optimal feature weight vector by inputting the optimal feature weight vector into the surrogate model; obtaining a simulated score of the optimal feature weight vector by simulating dispatches of the plurality of historical trips with prefiltering based on the optimal feature weight vector; determining whether a difference between the surrogate score and the simulated score is greater than a threshold; if the difference is greater than the threshold, retraining the surrogate model based at least on the optimal feature weight vector and the simulated score.

In some embodiments, the method 500 may further comprise: collecting one or more real-world KPI scores for each of a plurality of real-world dispatched orders based on the optimal feature weight vector; determining a real-world score for each of the plurality of real-world dispatched orders based on the one or more real-world KPI scores; and retraining the surrogate model based at least on the optimal feature weight vector and the plurality of real-world scores of the plurality of real-world dispatched orders.

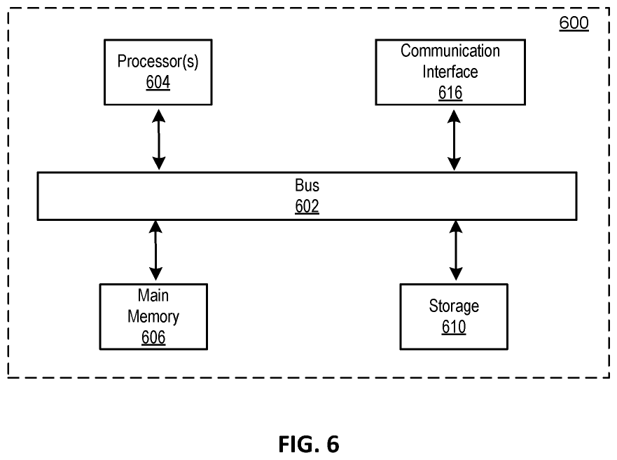

FIG. 6 illustrates an example computing device in which any of the embodiments described herein may be implemented. The computing device may be used to implement one or more components of the systems and the methods shown in FIGS. 1-7. The computing device 600 may comprise a bus 602 or other communication mechanism for communicating information and one or more hardware processors 604 coupled with bus 602 for processing information. Hardware processor(s) 604 may be, for example, one or more general purpose microprocessors.

The computing device 600 may also include a main memory 606, such as a random-access memory (RAM), cache and/or other dynamic storage devices 610, coupled to bus 602 for storing information and instructions to be executed by processor(s) 604. Main memory 606 also may be used for storing temporary variables or other intermediate information during execution of instructions to be executed by processor(s) 604. Such instructions, when stored in storage media accessible to processor(s) 604, may render computing device 600 into a special-purpose machine that is customized to perform the operations specified in the instructions. Main memory 606 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, or networked versions of the same.

The computing device 600 may implement the techniques described herein using customized hard-wired logic, one or more ASICs or FPGAs, firmware and/or program logic which in combination with the computing device may cause or program computing device 600 to be a special-purpose machine. According to one embodiment, the techniques herein are performed by computing device 600 in response to processor(s) 604 executing one or more sequences of one or more instructions contained in main memory 606. Such instructions may be read into main memory 606 from another storage medium, such as storage device 610. Execution of the sequences of instructions contained in main memory 606 may cause processor(s) 604 to perform the process steps described herein. For example, the processes/methods disclosed herein may be implemented by computer program instructions stored in main memory 606. When these instructions are executed by processor(s) 604, they may perform the steps as shown in corresponding figures and described above. In alternative embodiments, hard-wired circuitry may be used in place of or in combination with software instructions.

The computing device 600 also includes a communication interface 616 coupled to bus 602. Communication interface 616 may provide a two-way data communication coupling to one or more network links that are connected to one or more networks. As another example, communication interface 616 may be a local area network (LAN) card to provide a data communication connection to a compatible LAN (or WAN component to communicate with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function but can learn from training data to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

1. A computer-implemented method for prefiltering in a ride-hailing platform, the method comprising:
determining a feature weight matrix comprising a plurality of feature weight vectors, wherein each of the plurality of feature weight vectors comprises a plurality of feature weights corresponding to a plurality of features for prefiltering rider-driver pairs;
simulating dispatches of a plurality of historical trips with prefiltering based on each of the plurality of feature weight vectors in the feature weight matrix to obtain a plurality of scores, wherein the plurality of scores respectively correspond to the plurality of feature weight vectors;
training a surrogate model based on the plurality of feature weight vectors in the feature weight matrix and the plurality of scores, wherein the trained surrogate model takes a given feature weight vector as input and predicts a corresponding score;
constructing an optimization model comprising the surrogate model as an objective function and a plurality of decision variables corresponding to a plurality of feature weights of an optimal feature weight vector;
determining the optimal feature weight vector by solving the optimization model; and
prefiltering pending rider-driver pairs in the ride-hailing platform based on the optimal feature weight vector.

2. The method of claim 1, wherein determining the feature weight matrix comprises:
determining a plurality of feature weight matrix candidates;
determining a correlation coefficient for each of the plurality of feature weight matrix candidates; and
identifying, from the plurality of feature weight matrix candidates, the feature weight matrix with a minimum correlation coefficient.

3. The method of claim 2, wherein each of the plurality of features for prefiltering rider-driver pairs is associated with a weight range, and the determining a plurality of feature weight matrix candidates comprises:
for each of the plurality of features, dividing the corresponding weight range into a plurality of contiguous intervals of equal probabilities;
determining a feature weight matrix candidate comprising a plurality of candidate feature weight vectors, wherein each of the plurality of candidate feature weight vectors comprises a plurality of feature weights respectively selected from the plurality of contiguous intervals; and
repeating the step of determining a feature weight matrix candidate for a plurality of times to obtain the plurality of feature weight matrix candidates.

4. The method of claim 2, wherein the determining a correlation coefficient for each of the plurality of feature weight matrix candidates comprises:
determining a Pearson correlation coefficient for each pair of feature weight vectors in the each feature weight matrix candidate to obtain a plurality of Pearson correlation coefficients; and
determining a maximum Pearson correlation coefficient of the plurality of Pearson correlation coefficients as the correlation coefficient for the each feature weight matrix candidate.

5. The method of claim 1, wherein the simulating dispatches of a plurality of historical trips with prefiltering based on each of the plurality of feature weight vectors in the feature weight matrix to obtain a plurality of scores comprises, for each of the plurality of feature weight vectors:
determining one or more Key Performance Indicator (KPI) scores by dispatching the plurality of historical trips with prefiltering based on the feature weight vector in a simulation; and
determining a score for the feature weight vector as a weighted sum of the one or more KPI scores.

6. The method of claim 5, wherein the one or more KPI scores comprise at least one of the following: a trip completion rate, a number of trips, a gross merchandise value, a profit, a match rate, a matching efficiency measured by relative cost saving.

7. The method of claim 1, further comprising a re-training step that comprises:
obtaining a surrogate score of the optimal feature weight vector by inputting the optimal feature weight vector into the surrogate model;
obtaining a simulated score of the optimal feature weight vector by simulating dispatches of the plurality of historical trips with prefiltering based on the optimal feature weight vector;
determining whether a difference between the surrogate score and the simulated score is greater than a threshold; and
if the difference is greater than the threshold, retraining the surrogate model based at least on the optimal feature weight vector and the simulated score.

8. The method of claim 1, wherein the surrogate model comprises a Quadratic Polynomial Function.

9. The method of claim 1, further comprising:
collecting one or more real-world KPI scores for each of a plurality of real-world dispatched orders based on the optimal feature weight vector;
determining a real-world score for each of the plurality of real-world dispatched orders based on the one or more real-world KPI scores; and
retraining the surrogate model based at least on the optimal feature weight vector and the plurality of real-world scores of the plurality of real-world dispatched orders.

10. The method of claim 1, wherein the plurality of features comprise one or more of the following: travel distance from a driver to a rider and travel time from the driver to the rider.

11. The method of claim 1, wherein a rider-driver pair corresponds to a carpool order comprising a plurality of co-riders, and the plurality of features comprise at least one of the following features: a shared distance among the plurality of co-riders, a shared time among the plurality of co-riders, and a cost saving between the carpool order and a sum of hypothetical solo trip orders of the plurality of co-riders.

12. The method of claim 1, wherein the prefiltering pending rider-driver pairs in the ride-hailing platform based on the optimal feature weight vector comprises:
for each of the pending rider-driver pairs, determining a plurality of feature values corresponding to the plurality of features of the pending rider-driver pair based on rider information and driver information of the pending rider-driver pair;
determining a weighted sum of the plurality of feature values based on the plurality of feature weights in the optimal weight vector; and
selecting one or more of the pending rider-driver pairs with smallest weighted sums for order matching.

13. The method of claim 1, wherein the prefiltering pending rider-driver pairs in the ride-hailing platform based on the optimal feature weight vector comprises:
for each of the pending rider-driver pairs, determining a plurality of feature values corresponding to the plurality of features of the pending rider-driver pair based on rider information and driver information of the pending rider-driver pair;
determining a weighted sum of the plurality of feature values based on the plurality of feature weights in the optimal weight vector; and
selecting one or more of the pending rider-driver pairs with weighted sums smaller than a threshold for order matching.

14. A system comprising one or more processors and one or more non-transitory computer-readable memories coupled to the one or more processors, the one or more non-transitory computer-readable memories storing instructions that, when executed by the one or more processors, cause the system to perform operations comprising:
determining a feature weight matrix comprising a plurality of feature weight vectors, wherein each of the plurality of feature weight vectors comprises a plurality of feature weights corresponding to a plurality of features for prefiltering rider-driver pairs;
simulating dispatches of a plurality of historical trips with prefiltering based on each of the plurality of feature weight vectors in the feature weight matrix to obtain a plurality of scores, wherein the plurality of scores respectively correspond to the plurality of feature weight vectors;
training a surrogate model based on the plurality of feature weight vectors in the feature weight matrix and the plurality of scores, wherein the trained surrogate model takes a given feature weight vector as input and predicts a corresponding score;
constructing an optimization model comprising the surrogate model as an objective function and a plurality of decision variables corresponding to a plurality of feature weights of an optimal feature weight vector;
determining the optimal feature weight vector by solving the optimization model; and
prefiltering pending rider-driver pairs in the ride-hailing platform based on the optimal feature weight vector.

15. The system of claim 14, wherein the simulating dispatches of a plurality of historical trips with prefiltering based on each of the plurality of feature weight vectors in the feature weight matrix to obtain a plurality of scores comprises, for each of the plurality of feature weight vectors:
determining one or more Key Performance Indicator (KPI) scores by dispatching the plurality of historical trips with prefiltering based on the feature weight vector in a simulation; and
determining a score for the feature weight vector as a weighted sum of the one or more KPI scores.

16. The system of claim 14, wherein the operations further comprise:
obtaining a surrogate score of the optimal feature weight vector by inputting the optimal feature weight vector into the surrogate model;
obtaining a simulated score of the optimal feature weight vector by simulating dispatches of the plurality of historical trips with prefiltering based on the optimal feature weight vector;
determining whether a difference between the surrogate score and the simulated score is greater than a threshold; and
if the difference is greater than the threshold, retraining the surrogate model based at least on the optimal feature weight vector and the simulated score.

17. A non-transitory computer-readable storage medium storing instructions that, when executed by one or more processors, cause the one or more processors to perform operations comprising:
determining a feature weight matrix comprising a plurality of feature weight vectors, wherein each of the plurality of feature weight vectors comprises a plurality of feature weights corresponding to a plurality of features for prefiltering rider-driver pairs;
simulating dispatches of a plurality of historical trips with prefiltering based on each of the plurality of feature weight vectors in the feature weight matrix to obtain a plurality of scores, wherein the plurality of scores respectively correspond to the plurality of feature weight vectors;
training a surrogate model based on the plurality of feature weight vectors in the feature weight matrix and the plurality of scores, wherein the trained surrogate model takes a given feature weight vector as input and predicts a corresponding score;
constructing an optimization model comprising the surrogate model as an objective function and a plurality of decision variables corresponding to a plurality of feature weights of an optimal feature weight vector;
determining the optimal feature weight vector by solving the optimization model; and
prefiltering pending rider-driver pairs in the ride-hailing platform based on the optimal feature weight vector.

18. The storage medium of claim 17, wherein the simulating dispatches of a plurality of historical trips with prefiltering based on each of the plurality of feature weight vectors in the feature weight matrix to obtain a plurality of scores comprises, for each of the plurality of feature weight vectors:
determining one or more Key Performance Indicator (KPI) scores by dispatching the plurality of historical trips with prefiltering based on the feature weight vector in a simulation; and
determining a score for the feature weight vector as a weighted sum of the one or more KPI scores.

19. The storage medium of claim 17, wherein the operations further comprise:
obtaining a surrogate score of the optimal feature weight vector by inputting the optimal feature weight vector into the surrogate model;
obtaining a simulated score of the optimal feature weight vector by simulating dispatches of the plurality of historical trips with prefiltering based on the optimal feature weight vector;
determining whether a difference between the surrogate score and the simulated score is greater than a threshold; and
if the difference is greater than the threshold, retraining the surrogate model based at least on the optimal feature weight vector and the simulated score.

20. The storage medium of claim 17, wherein the plurality of features comprise one or more of the following: travel distance from a driver to a rider and travel time from the driver to the rider.
